(19) United States
(12) Patent Application Publication
(10) Pub. No.: US 2017/0031862 A1
(43) Pub. Date: Feb. 2, 2017

(54) DUAL-BUS SEMICONDUCTOR CHIP PROCESSOR ARCHITECTURE

(71) Applicant: Seloco, Inc., Seoul (KR)

(72) Inventor: Young Uk Yu, Songpa-gu (KR)

(21) Appl. No.: 15/019,076

(22) Filed: Feb. 9, 2016

(30) Foreign Application Priority Data
Jul. 31, 2015 (KR) 10-2015-0108942

(51) Int. Cl. G06F 13/42; G06F 13/16; G06F 13/38

(52) U.S. Cl. CPC G06F 13/4286; G06F 13/385; G06F 13/1605

(57) ABSTRACT

A semiconductor chip processor structure comprises a main bus which allows for direct control of internal functional blocks by a micro controller unit (MCU); a sub bus whose clock frequency is higher than the main bus; a memory access which carries out direct memory access actions and controls the external peripherals; an image processing unit which causes transmission of compressed image data to the external peripherals; and an audio processing unit that causes transmission of audio data input from an external audio codec unit to external peripherals or audio data transmitted from external peripherals to be transmitted to the external audio codec unit. Using an additional 8-bit high speed bus to transmit ≧1 megapixel images ≧12 frames per second through an 8-bit micro controller operating with an organic combination of multifunctional image sensor functions for IoT system on chip processors makes high performance image processing in 8-bit MCUs possible.

### CROSS-REFERENCE TO RELATED PATENT APPLICATIONS

This application claims priority from Korean Application No. 10-2015-0108942, filed on Jul. 31, 2015, and entitled “Semiconductor Chip Processor Architecture for Improving Processing Speed having Dual Bus,” which is incorporated herein by reference in its entirety.

### BACKGROUND

Generally, system on chip processors refer to integrated circuits (ICs) where a microprocessor, internal memory, functional blocks (image processing, voice processing, high speed computing, etc.), multiple peripherals and external bus interfaces, etc., are loaded in a single chip.

The development of such system on chip processors has allowed the reduction of system size, in addition to shortening system validation time, enhancing system reliability, and reducing product prices as well as the time required for launch of products in the market.

Among system on chip processors, multimedia system on chip processors include, on a single chip, circuits to perform various functions necessary in multimedia devices.

In the process of the progress of multimedia system on chip processors, early chips contained single-function circuits such as DCT (Discrete Cosine Transform) or ME (Motion Estimator). Later, Static Random-Access Memory (SRAM) or Boot Read-Only Memory (ROM) was added, and later chips also included high capacity Synchronous Dynamic Random-Access Memory (SDRAM). With the development of technology, even more additional functions are being integrated.

However, the microprocessors used in the process of engineering multimedia system on chip processors generally have a processing speed of 16 bits or 32 bits for the computations necessary for multimedia processing and to allow for sufficient transmission speed. Using video compression methods such as MPEG or H.264, their focus has been on the transmitting of video.

Therefore, as the number of processing speed bits increased, power consumption and the area of silicon required also increased, driving manufacturing prices up.

### SUMMARY

The present technology relates to a semiconductor chip processor architecture with improved processing speed through a dual bus. More specifically, the present technologyrelates to a semiconductor chip processor architecture whose processing speed has been improved with an additional 8 bit high speed bus to allow for transmission of images of 1 megapixel or greater at 12 frames or higher per second through a micro controller unit with a processing speed of 8 bits.

The present technology, which can address the problem described above, has an additional 8-bit high speed bus to transmit images of 1 megapixel or greater at a rate of 12 frames or more per second through a micro controller having an 8 bit processing speed. The present technology can operate with an organic combination of only the multifunctional image sensor functions necessary for IoT system on chip processors. Embodiments of the present technology provide a semiconductor chip processor structure with enhanced processing speed with a dual bus to make high performance image processing possible in low-priced 8 bit micro controller units.

To achieve the objectives described above, the semiconductor chip processor structure with enhanced processing speed with a dual bus comprises a micro controller unit with an 8 bit processing capacity and bus in a semiconductor chip processor structure with relatively low power consumption. The micro controller unit is connected to the semiconductor chip processor's internal function blocks, which may include: a main bus with an 8 bit processing capacity which allows for direct control of the internal functional blocks of the semiconductor chip processor by the micro controller unit; a sub bus with a processing capacity of 8 bits which is connected to the main bus and has a higher clock frequency and data processing speed than the main bus, controlling external peripherals; a memory access unit having a relatively low clock frequency, performing direct memory access without control from the micro controller unit to access the data memory of the micro controller unit, and to control the external peripherals connected to the sub bus; an image processing unit which compresses the image data received from external image sensors and causes the compressed image data to be transmitted to the external peripherals according to the control of the memory access unit; and an audio processing unit which causes audio data input from external audio codecs to be transmitted to external peripherals according to the control of the memory access unit, or causes audio data received from external peripherals to be transmitted to external audio codec units according to the control of the memory access unit.

Between the main bus and sub bus may be included a bridge unit which performs synchronization to process signals with different operating frequencies, and a priority arbiter unit which prevents data collisions in the sub bus.

The priority arbiter unit processes commands by order of priority in the sub bus, preventing data collisions, and, between the micro controller unit and the memory access unit, can process commands received from the micro controller unit with a higher priority.

The clock frequency of the main bus is 7.384610 MHz or 7.384620 MHz, and the clock frequency of the sub bus may be 75 MHz or 80 MHz.

As for the internal functional blocks connected to the main bus, a timer unit which creates an arbitrary timing to perform the role of generating events or counting the number of events generated, a pulse width modulator unit, a watchdog timer unit which prevents the micro controller unit from malfunctioning and falling into an infinite routine, a Universal Asynchronous Receiver/Transmitter (UART) unit for RS 232 communication, an external interrupt unit which performs the role of combining one of multiple interrupts and makes one of the interrupts of the micro controller unit usable, a serial computer bus for serial communications, and general input/output units may be included.

As for the external peripherals connected to the sub bus, a Secure Digital (SD) connector unit which connects to the serial connection bus and is controlled by the memory access unit, an Analog-to-Digital Conversion (ADC) unit, WiFi and ZigBee units, a wired Local Area Network (LAN) unit that is connected to the memory control unit and is controlled through the memory access unit, and external memory that is connected to the memory arbiter unit and controlled through the memory access unit may be included.

The image data input sent to the image processing unit is compressed in the image encoder unit and saved in image memory, and may be saved in external memory through the memory arbiter unit.

In the audio processing unit, the audio data input received from the external audio codec unit is saved in input memory through the audio connection unit, then sent to the external peripherals. The audio data received from the external peripherals is saved in output memory, and may be sent to the external audio codec unit through the audio connection unit.

A semiconductor chip processor structure with dual bus for improved processing speed, having an additional 8-bit high speed bus to transmit images of 1 megapixel or greater at a rate of 12 frames or more per second through a micro controller having an 8 bit processing speed, and designed to operate with an organic combination of only the multifunctional image sensor functions necessary for IoT system on chip processors, provides several benefits, including the benefit of high performance image processing in low-priced 8 bit micro controller units (MCUs).

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a diagram depicting a semiconductor chip processor structure with a dual bus for improved processing speed according to one embodiment of the present invention.

FIG. 2 is an exemplary view showing the hardware structure of the semiconductor chip processor structure with a dual bus for improved processing speed according to one embodiment of the present invention.

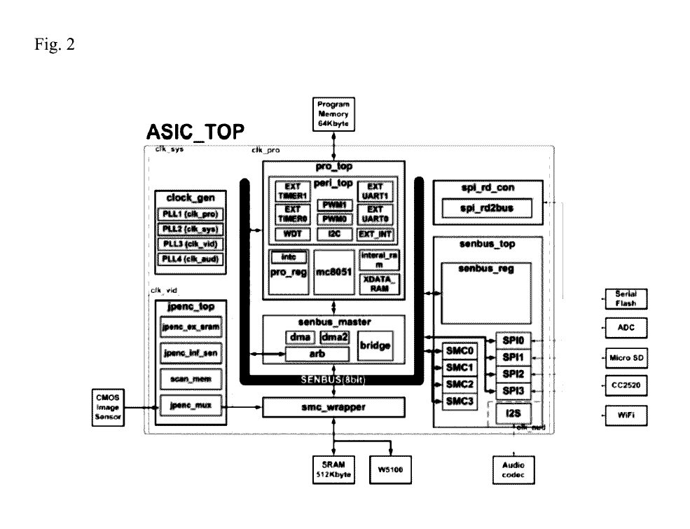

FIG. 3 is an exemplary view depicting a layout of the structure of the semiconductor chip processor structure with a dual bus for improved processing speed according to one embodiment of the present invention.

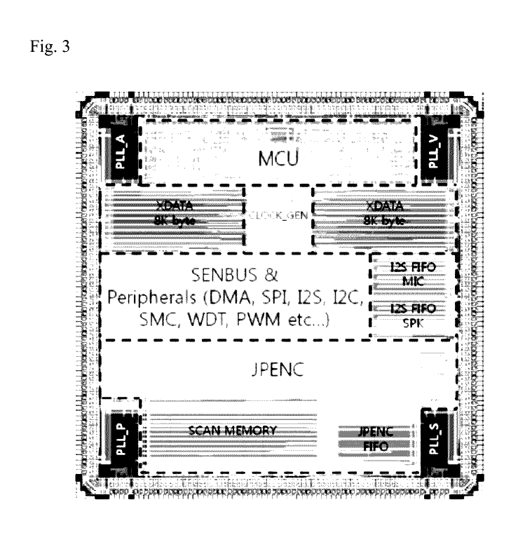

### DETAILED DESCRIPTION

In the following, the embodiments of the present technology are described in more detail with reference to the various figures of the drawings, so that a person having ordinary skill in the art may readily carry out the present technology.

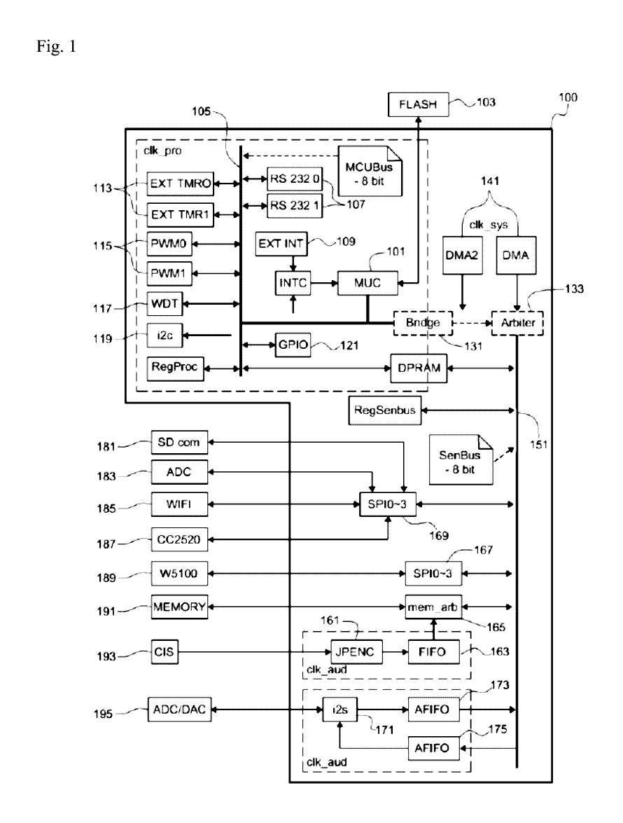

The semiconductor chip processor structure with dual bus for improved processing speed (100), as depicted in FIG. 1, is comprised of a micro controller unit (101), internal functional blocks of the semiconductor chip processor (hereinafter referred as ‘internal functional blocks’), a main bus (105), a memory access unit (141), a sub bus (151), an image processing unit, and an audio processing unit.

A micro controller unit (101) is a micro controller unit (MCU) with an 8 bit processing capacity, compatible with Intel Standard 8051.

Integrated into the semiconductor chip processor structure (100) is data memory (DPRAM) with 16 KByte storage capacity for a micro controller unit (101) having dual ports for access not only to a micro controller unit (101) but also a memory access unit (Direct Memory Access (DMA); 141) described below.

Unexplained code number 103 represents external flash memory which is furnished separately.

A main bus (105) has 8 bits of processing capacity, and connects the micro controller unit (101) and the internal functional blocks, allowing the micro controller unit (101) to control the internal functional blocks directly.

The clock frequency of the main bus (105) is 7.384615 MHz, and, as the data rate is not high, high speed data transmission is carried out through a sub bus (151), which is described below.

The semiconductor chip processor structure (100), using 4 individual Phase-Locked Loops (PLLs) for independent operation of four clocks, can reduce power consumption.

The internal functional blocks connected to the main bus (105) are 2 timer units that carry out the role of generating events or counting the number of events generated (13), 2 pulse width modulator units which change the width of pulses depending on the level changes of the input signal (115), a watchdog timer unit (117) which resets the switch at the predetermined time to prevent the micro controller unit (101) from malfunctioning and falling into an infinite routine, 2 UART units (107) supporting a baud rate of up to 230400 bps for RS232 communication, an external interrupt unit (109) which mixes and receives one of up to 16 interrupts, then allows interrupt 1 among the 2 external interrupts had by a micro controller unit (101), and a general input/output unit (121) which, together with the UART units (107) or the serial connection bus (SPI; 169) to be described below, allows the use of 32 bit in addition to the GPIO (General Purpose I/O) P1 and P3 supported by a serial computer bus (119) for serial communication and a micro controller unit (101).

A sub bus (151) is a bus with an 8 bit processing capacity, which is connected to the main bus (105), having a higher clock frequency than the main bus (105) and controlling the external peripherals at a high data processing speed.

The clock frequency of a sub bus (151) is 78 MHz.

For a micro controller unit (101) to use a sub bus (151), an interface through a bridge unit (131) and a priority arbiter unit (133) is required. Transmission and receiving of large amounts of data at high speeds is possible through 2 memory access units (141).

A bridge unit (131) performs synchronization for processing of signals with different clock domains, and a priority arbiter unit (133) processes commands according to priority in a sub bus (151) to prevent the occurrence of data collisions.

The priority arbiter unit (133) receives commands entered from a micro controller unit (101) and a memory access unit (141), and processes commands entered from a micro controller unit (101) with higher priority.

A memory access unit (141) has a relatively low clock frequency and carries out a memory access action directly, without control from the micro controller unit (101) which has a low speed, to access the data memory (DPRAM) of a micro controller unit (101) and to control the external peripherals connected to the sub bus (151).

Therefore, through a memory access unit (141), the relatively high speed sub bus (151) is unaffected by the relatively low speed micro controller unit (101), and image data following the image compression to be described below can be transmitted to external peripherals directly through the high speed sub bus (151).

The external peripherals connected to the sub bus (151) are an SD connection unit (181) controlled through a memory access unit (141) and connecting to a serial connection bus (169; SPI); an ADC unit (183), WiFi unit (185), and ZigBee unit (187); a wireless LAN unit (189) controlled through a memory access unit (141) and connecting to a memory control unit (167; SMC); and external memory (191) controlled through a memory access unit (141) and connecting to a memory arbiter unit (165).

Up to 4 of the serial connection buses (169) are supported, and are controlled through a memory access unit (141).

The memory arbiter unit (165) provides a function that allows appropriate selection and use of various types of memory according to individual control signals, and a serial connection bus (169) is to connect the faster internal image processing speed to be described below to external communication functions (WiFi, Zigbee, Ethernet, etc.) to allow for fast transmission speeds.

An image processing unit compresses image data received from an external image sensor (193), then transmits the compressed image data to external peripherals according to control by the memory access unit (141), with the image data received from an image sensor (193) being saved in image memory (163) after compression in an image encoder unit (161), then being saved in external memory (191) through a high speed sub bus (151) via a memory arbiter unit (165).

In the present technology, the sub bus (151) for image processing has a clock frequency of 78 MHz and is used for high speed transmission of images, and a separate encoding clock frequency of 48 MHz is used for compression of image data received from an image sensor (193) in an image encoder unit (161) to allow for response to changes in clock frequency depending on the type of image sensor (CIS).

As described above, by adding an additional high speed sub bus (151) to create a dual bus structure, image data with a size of 1 MByte or greater can be transmitted at 12 frames per second using a micro controller unit with an 8 bit processing capacity.

Whereas such high speed transmission functions are used conventionally in high performance computers or CPUs, in the present tehcnology, designed to operate with an organic combination of only the multifunctional image sensor functions necessary for multifunctional image sensor system on chip processors, high performance image processing is possible in low-cost 8 bit micro controller units.

An audio processing unit causes audio data received from an external audio codec unit (195) to be controlled by a memory access unit (141) and transmitted to external peripherals through a sub bus (151), or causes audio data received from external peripherals to be controlled by the memory access unit (141) and transmitted to an external audio codec unit (195).

That is, in the audio processing unit, audio data input received from an audio codec unit (195) is saved in input memory (173) through an audio connection unit (171) then transmitted to external peripherals, and audio data received from external peripherals is saved in output memory (175) then transmitted to an external audio codec unit (195) through an audio connection unit (171).

The input memory (173) and output memory (175) have 2 KB of capacity, respectively, and are connected to a sub bus (151).

The audio processing unit also has a separate audio processing clock frequency of 16.5 MHz, and is therefore capable of voice signal processing.

Therefore, in the present technoloy, to make possible a dedicated Internet of Things (IoT) system on chip capable of readily processing image data, audio data, and multi sensor data, different image processing and audio processing clock frequencies have been engineered in to bring about general performance enhancements.

The fabrication of the semiconductor chip processor has been performed using an SMIC 0.18 μm process as the target foundry. Total IO count is 278 pins, with 174 signal pins and 104 power/GND pins.

The target package is fabricated as BGA256, and detailed specs are shown in TABLE 1.

TABLE 1

| Clock | 78 MHz (SENBUS), 7.384615 MHz (MCU) |
|---|---|
| | 16.5 MHZ (Audio), 48 MHz (JPENC) |
| 8-bit MCU | Intel standard 8051 compatible (MC8051) |
| | 2 Timer, 1 UART, 16 GPIO, 5 Interrupt |
| | 64 KB Data Memory (off-chip memory) |
| | 16 KB Data Memory (on-chip memory) |
| | 48 KB Data Memory (off-chip memory) |
| JPEG | Compatible to JPEG baseline standard |
| Image save memory | Off-chip memory (1 MB) |
| Peripherals | I2S, WDT, 2 PWM, I2C, 2 EXT_UART |
| | 2 EXT_Timer, 2 DMA, 4 SPI |
| EXT (External) GPIO | 32 bit |
| EXT (External) Interrupts | 16 ea (12 internal int + 4 external bit) |
| Data rate | 38.4 kbps (Max, using UART) |
| | 400 kHz (I2C) |
| | 230.4 kbps (Max, using EXT UART) |
| | 18 Mbps (Max, using SPI) |
| | 19.5 Mbyte (Max, using DMA) |
| | 8 kbps (I2S) |
| Image Resolution | Max SXGA (1280 × 1024), 1.3 Mpixels |
| Frame rate | Max 12 fps@SXGA |
| System bus | AMBA like bus architecture |
| | 8-bit MCUbus |
| | 8-bit SenBus |
| EXT SRAM access | 4 ea (using SMC) |
| Memory arbiter | 0 |

According to the semiconductor chip processor structure with dual bus for improved processing speed described in the above, by engineering an additional 8-bit high speed bus to transmit images of 1 megapixel or greater at a rate of 12 frames or more per second through a micro controller having an 8 bit processing speed, and designing to allow operation with an organic combination of only the multifunctional image sensor functions necessary for IoT system on chip processors, high performance image processing in low-priced 8 bit MCUs is possible.

While, in the above, the present technology has been described with reference to its desirable embodiments, it will be understood by those with ordinary skill in the art that various changes may be made and equivalents may be substituted for elements thereof without departing from the essential scope of the invention. Therefore, it is intended that the invention not be limited to the particular embodiments disclosed as the best mode contemplated for carrying out this invention.

### DESCRIPTION OF REFERENCE NUMERALS

101: Micro controller unit
105: Main bus
141: Memory access unit
151: Sub bus
161: Image encoder unit
163: Image memory
171: Audio connection unit
173: Input memory
175: Output memory
193: Image sensor
195: Audio codec unit

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of designing and making the technology disclosed herein may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes (e.g., of designing and making the technology disclosed above) outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A semiconductor chip processor structure comprising:
a plurality of internal functional blocks;
a micro controller unit with 8 bits of processing capacity;
a main bus having 8 bits of processing capacity and connecting the micro controller unit with the plurality of internal functional blocks to allow for direct control of the plurality of internal functional blocks of by the micro controller unit;
a sub bus with 8 bits of processing capacity, connected to the main bus and to at least one external peripheral, the sub bus, to allow control of the at least one external peripheral, the sub bus having a clock frequency higher than that of the main bus;
a memory access unit, to carry out direct memory access actions without being controlled by the micro controller unit and to control the at least one external peripheral connected to the sub bus;
an image processing unit to compress image data input received from an external image sensor and to cause the image data to be transmitted to the at least one external peripherals according to control by the memory access unit; and
an audio processing unit to cause audio data input received from an external audio codec unit to be transmitted to the at least one external peripheral according to control by the memory access unit and/or to cause audio data transmitted from the at least one external peripheral to be transmitted to the external audio codec unit according to control by the memory access unit.

2. The semiconductor chip processor structure according to claim 1, further comprising:
a bridge unit to synchronize processing of signals with different operating frequencies; and
a priority arbiter unit to prevent data collisions between the main bus and sub bus.

3. The semiconductor chip processor structure according to claim 2, wherein the priority arbiter unit is configured to process commands within the sub bus depending on priority to prevent data collisions and to process, between commands received between the micro controller unit and the memory access unit, commands received from the micro controller unit with a higher priority than other commands.

4. The semiconductor chip processor structure according to claim 1, wherein the main bus has a clock frequency of 7.384610 MHz, and the clock frequency of the sub bus is 75 MHz.

5. The semiconductor chip processor structure according to claim 1, wherein the main bus has a clock frequency of 7.384610 MHz, and the clock frequency of the sub bus is 80 MHz.

6. The semiconductor chip processor structure according to claim 1, wherein the main bus has a clock frequency of 7.384620 MHz, and the clock frequency of the sub bus is 75 MHz.

7. The semiconductor chip processor structure according to claim 1, wherein the main bus has a clock frequency of 7.384620 MHz, and the clock frequency of the sub bus is 80 MHz.

8. The semiconductor chip processor structure according to claim 1, wherein the plurality of internal functional comprises at least one of:
a timer unit to create an arbitrary timing to perform the role of generating events or counting the number of events generated,
a pulse width modulator unit,
a watchdog timer unit to prevent the micro controller unit from malfunctioning and falling into an infinite routine,
a Universal Asynchronous Receiver/Transmitter (UART) unit for RS 232 communication,
an external interrupt unit to combine multiple interrupts and to make at least one of the interrupts of the micro controller unit usable,
a serial computer bus for serial communications, or
at least one general input/output unit.

9. The semiconductor chip processor structure according to claim 1, wherein the at least one external peripheral comprises at least one of:
an Secure Digital (SD) connector unit connected to the serial connection bus and is configured to be controlled by the memory access unit,
an Analog-to-Digital Conversion (ADC) unit,
a WiFi unit,
a ZigBee unit,
a wired Local Area Network (LAN) unit connected to the memory control unit and configured to be controlled through the memory access unit, and
external memory connected to a memory arbiter unit and configured to be controlled through the memory access unit.

10. The semiconductor chip processor structure according to claim 9, wherein the image encoder unit is configured to compress the image data entered into the image processing unit and the external memory is configured to save the image data and through the memory arbiter.

11. The semiconductor chip processor structure according to claim 9, wherein, in the audio processing unit, the input memory is configured to save audio data input from the external audio codec unit through the audio connection unit before transmission to the at least one external peripheral, and the output memory is configured to save audio data received from the at least one external peripheral before transmission to the external audio codec unit through the audio connection unit.
